(19) United States
(12) Patent Application Publication
(10) Pub. No.: US 2025/0379947 A1
(43) Pub. Date: Dec. 11, 2025

(54) IMAGE FORMING APPARATUS AND STORAGE MEDIUM

(71) Applicant: Konica Minolta, Inc., Tokyo (JP)

(72) Inventors: Tsumoru MATSUURA, Toyohashi-shi (JP); Shin OHBA, Toyokawa-shi (JP)

(21) Appl. No.: 19/225,464

(22) Filed: Jun. 2, 2025

(30) Foreign Application Priority Data
Jun. 5, 2024 (JP) 2024-091107

(51) Int. Cl. H04N 1/00; G03G 15/00; G03G 21/02; H04N 1/32

(52) U.S. Cl. CPC H04N 1/00538; G03G 15/5016; G03G 21/02; H04N 1/32101; H04N 2201/3269; H04N 2201/3273

(57) ABSTRACT

An image forming apparatus including a unit and an image forming apparatus main body to which the unit is attached is described, the image forming apparatus including: an image former that forms an image on a sheet; and a hardware processor that forms, on the sheet by the image former, a print image including state information indicating a state of the unit to be handed over from the image forming apparatus from which the unit is detached to the image forming apparatus to which the unit is attached in a refurbish operation, and displays, on a display, at least a portion of the print image indicating the state information.

### BACKGROUND OF THE INVENTION

### Technical Field

The present invention relates to an image forming apparatus and a storage medium.

### Description of Related Art

A typical image forming apparatus includes a main body and a plurality of units attached to the main body. The units are consumable items and replaced at appropriate timing.

In this regard, Japanese Unexamined Patent Publication No. 2010-266757 discloses an image forming apparatus in which, when a used unit is attached to the image forming apparatus main body, a setting change is performed in accordance with the used unit.

Japanese Unexamined Patent Publication No. 2011-69951 describes the image forming apparatus that resets a count value of a cumulative total of printed sheets to 0 for a new unit when a user removes an old unit that has reached an end of life from the image forming apparatus main body and attaches a new unit.

Japanese Unexamined Patent Publication No. 2019-64190 describes the image forming apparatus that acquires, before replacement of a component in the image forming apparatus, information indicating a status of use of the component and holds the information in a nonvolatile storage section.

In recent years, there has been a demand to eliminate wasteful disposal to realize a recycling society. In a reusing operation, a reusable unit having a remaining life is detached from the main body of a discarded image forming apparatus, and the unit is attached to a main body of another image forming apparatus as a reusing-target apparatus. In the reusing operation, it is necessary to take over the counter information regarding the use history of the used unit when the used unit is attached to the reusing-target apparatus.

In a case where the counter information is stored in the storage device of the image forming apparatus main body, the operator takes over the counter information by the following method in the reusing operation. Specifically, the operator prints, on a sheet, a quick response (QR) code (registered trademark) including the counter information of the unit to be removed in the image forming apparatus that is a provider of the unit. Next, the operator causes the image forming apparatus to which the unit is to be provided to acquire the counter information of the unit by reading the QR code printed on the sheet.

However, when the image forming section of the image forming apparatus of the providing source has a problem, the QR code including the counter information cannot be printed on the sheet. In this case, there is a problem that the counter information of the used unit cannot be efficiently handed over in the reusing operation of the image forming apparatus.

### SUMMARY OF THE INVENTION

An object of the present invention is to provide an image forming apparatus and a storage medium that can suitably transfer, to a receiver apparatus, information indicating a state of a unit removed from a provider apparatus.

To solve the above-described problem, according to an aspect of the present invention, an image forming apparatus reflecting one aspect of the present invention is the image forming apparatus including a unit and an image forming apparatus main body to which the unit is attached, the image forming apparatus including:
an image former that forms an image on a sheet;
and a hardware processor that forms, on the sheet by the image former, a print image including state information indicating a state of the unit to be handed over from the image forming apparatus from which the unit is detached to the image forming apparatus to which the unit is attached in a refurbish operation, and displays, on a display, at least a portion of the print image indicating the state information.

According to another aspect of the present invention, a non-transitory computer readable storage medium reflecting one aspect of the present invention is the storage medium storing a program that causes a computer of an image forming apparatus including a unit, an image forming apparatus main body to which the unit is attached, and an image former that forms an image on a sheet, to perform:
forming, on the sheet by the image former, a print image including state information indicating a state of the unit to be handed over from the image forming apparatus from which the unit is detached to the image forming apparatus to which the unit is attached in a refurbish operation, and displaying, on a display, at least a portion of the print image indicating the state information.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a schematic configurational view of an image forming apparatus according to the present invention;

FIG. 2 is a block diagram illustrating a functional configuration of the image forming apparatus;

FIG. 3 is a flowchart showing a flow of a counter information display process;

FIG. 4 is a diagram illustrating a sheet on which handover information is printed;

FIG. 5 is a diagram illustrating an example of a refurbish screen displayed on a display part;

FIG. 6 is a diagram illustrating an example of the refurbish screen displayed on the display part;

FIG. 7 is a diagram illustrating an example of the refurbish screen displayed on the display part;

FIG. 8 is a flowchart illustrating a flow of the counter information display process according to modification example 1;

FIG. 9 is a flowchart illustrating the flow of the counter information display process according to modification example 2; and

FIG. 10 is a flowchart showing the flow of the counter information display process according to modification example 3.

### DETAILED DESCRIPTION

Hereinafter, one or more embodiments of the present invention will be described with reference to the drawings. However, the scope of the invention is not limited to the disclosed embodiments.

Hereinafter, an embodiment of the present invention will be described with reference to the drawings. However, the scope of the invention is not limited to the illustrated examples.

### 1. Configuration of Image Forming Apparatus

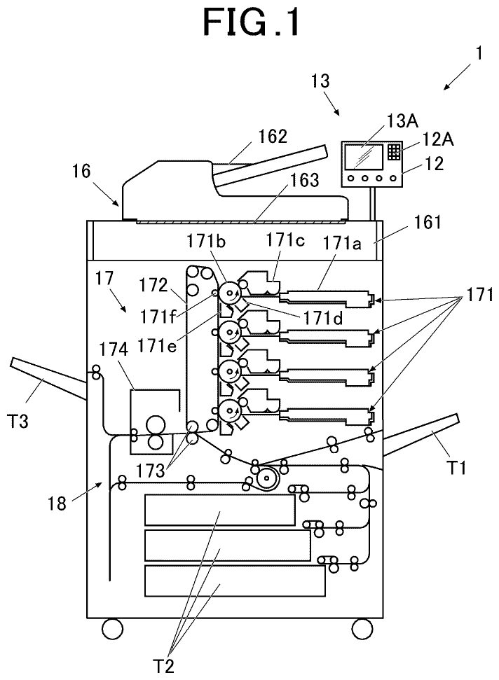

FIG. 1 is a schematic configuration diagram of an image forming apparatus 1 according to the present embodiment. FIG. 2 is a block diagram illustrating a functional configuration of the image forming apparatus 1.

The image forming apparatus 1 is a multi-function peripheral (MFP) having a copy function, a scan function, a facsimile function, and the like in addition to an image forming function.

In the reusing operation of the image forming apparatus 1, an operator of a manufacturer takes out a reusable used unit from the image forming apparatus 1. Herein, the main body of the image forming apparatus 1 is to be discarded (discarded apparatus). Next, the operator attaches the used unit which has been taken out from the discarded apparatus to the image forming apparatus 1 which is another apparatus that can be reused. The manufacturer sells or rents the image forming apparatus 1 attached with the used unit as a reusing-target apparatus.

The image forming apparatus 1 includes a controller 11 (hardware processor), an operation part 12, a display part (display) 13, a communication section 14, a storage section 15, a document reading section 16, an image forming section (image former) 17, a conveyance section 18, a waste toner collecting section 19, and an detachment/attachment sensing section (sensing section, sensor) 20.

The controller 11 includes a central processing unit (CPU), a random access memory (RAM), and the like.

The CPU of the controller 11 reads a program stored in the storage section 15, deploys the program to the RAM, and controls components of the image forming apparatus 1 in accordance with the deployed program. For example, the controller 11 performs image processing on image data of a job on the basis of settings of a job input from outside via the communication section 14. Next, the controller 11 causes the conveyance section 18 to feed a sheet and causes the image forming section 17 to form and fix an image on the sheet.

The operation part 12 includes operation keys 12A, and a touch screen integrally formed with the display part 13, and outputs an operation signal corresponding to an operation thereon to the controller 11.

The display part 13 includes a liquid crystal display (LCD) panel 13A. The display part 13 displays display information, such as an operation screen, in accordance with instructions by the controller 11.

The communication section 14 includes a network card and is connected to a communication network. The communication section 14 sends and receives information to and from external apparatuses over the communication network.

The storage section 15 includes a storage device such as a nonvolatile semiconductor memory and a hard disk.

The storage section 15 stores programs and files readable by the controller 11.

The storage section 15 stores, for each detachable unit included in the image forming apparatus 1, state information indicating a state of the unit. The state information of the unit is, for example, counter information of the unit. The counter information of the unit is initialized to “0” again, for example, when the unit is replaced with a new one. The counter information of the unit will be described in detail later. The state information of the unit may be a value or the like obtained by detecting deterioration of a main part of the unit with a sensor.

The document reading section 16 includes an automatic document feeder, a scanner 161, a placement tray 162 on which a document sheet is placed, and a platen glass 163.

The automatic document feeder includes a mechanism for feeding document sheets and document conveyance rollers. The automatic document feeder feeds the document sheet to a predetermined conveyance route under the control of the controller 11.

The scanner 161 includes a light source, an optical system such as a reflecting mirror, and imaging elements. The scanner 161 reads images on the document sheet conveyed along a predetermined conveyance route or an image on the document sheet placed on the platen glass 163.

The image forming section 17 forms images of four colors of C, M, Y, and K on the sheet, based on four-color pixel values of pixels constituting the image data subjected to image processing.

As shown in FIG. 1, the image forming section 17 includes four writing units 171, an intermediate transfer belt 172, secondary transfer rollers 173, and a fixing unit 174.

The four writing units 171 for the respective four colors of C, M, Y, and K are arranged in series (tandem) along a surface of the intermediate transfer belt 172 to form images in the C, M, Y, and K colors on the sheet.

Each of the writing units 171 includes an exposure section 171a, a photosensitive drum unit 171b, a developing section 171c, a charging section 171d, a cleaning section 171e, and a primary transfer roller 171f.

The photosensitive drum unit 171b includes a rotating conductive cylindrical body (photoreceptor). The charging section 171d charges the photoreceptor. The exposure section 171a has a semiconductor laser light source. Under the control of the controller 11, the exposure section 171a drives the semiconductor laser light source based on the image data and, with the laser light, irradiates the photoreceptor charged by the charging section 171d to expose the photoreceptor. Under the control of the controller 11, the developing section 171c supplies toner onto the photoreceptor using the charged developing roller and develops an electrostatic latent image formed on the photoreceptor by exposure. The images formed on the respective photoreceptors of the four writing units 171 are sequentially transferred on one another onto the intermediate transfer belt 172 by the respective primary transfer rollers 171f (primary transfer). Thus, the toner image including each color is formed on the intermediate transfer belt 172. After the primary transfer, the cleaning section 171e removes the toner remaining on the photoreceptor.

The intermediate transfer belt 172 is an endless belt stretched around a plurality of rollers and is rotated by the rotations of the rollers under the control of the controller 11.

Under the control of the controller 11, the second transfer rollers 173 transfer the toner image, which is formed on the intermediate transfer belt 172, onto the sheet conveyed from a manual sheet feed tray T1 or a sheet feed tray T2 (secondary transfer).

The fixing unit 174 includes a heating roller and a pressure roller.

Under the control of the controller 11, the fixing unit 174 applies heat and pressure to the sheet with the image formed thereon so as to fix the image on the sheet.

The conveyance section 18 includes a sheet feeding roller. In accordance with instructions by the controller 11, the conveyance section 18 conveys the sheet from the manual sheet feed tray T1 or the sheet feed tray T2 to the image forming section 17 by the sheet feeding rollers. The conveyance section 18 ejects the sheet subjected to fixing by the fixing unit 174 to the sheet ejection tray T3.

The conveyance section 18 has an inversion section that serves as a sheet inversion route. When performing double-sided printing, the sheet with the image fixed on a front side is inverted and returned to the image forming section 17.

The waste toner collecting section 19 includes a waste toner conveyance unit and a waste toner collecting container.

With the waste toner conveyance unit, the waste toner collecting section 19 conveys waste toner removed in the image forming section 17 and accumulates the waste toner in the waste toner collecting container.

The detachment/attachment sensing section 20 senses, for each unit, that the unit is attached to the main body of the image forming apparatus 1 and that the unit is detached from the main body of the image forming apparatus 1. The detachment/attachment sensing section 20 outputs a sensing result to the controller 11.

### 2. Unit Counter Information

The counter information of the unit stored in the storage section 15 is information indicating a degree of wear of the unit.

The unit detachable from the main body of the image forming apparatus 1 are an operation key 12A, an LCD panel 13A, the photosensitive drum unit 171b, a developing unit of the developing section 171c, a toner unit of the developing section 171c, a transfer belt unit including the intermediate transfer belt 172, a transfer roller unit including the secondary transfer roller 173, the fixing unit 174, a waste toner conveyance unit of the waste toner collecting section 19, and the like.

The counter information of the unit includes at least one of a number of times of pressure contact, a travel distance, a travel time, a predetermined temperature cumulative time, a maximum sheet passing distance, the number of printed (image formation) sheets, and an energization time.

The number of times of pressure contact is a cumulative number of times of pressure contact from a time point from a state where the unit is new to a current time point. The number of times of pressure contact is, for example, information corresponding to the fixing unit 174 or the like.

The travel distance is an accumulated travel distance from the state where the unit is new to the current time point. The travel distance is, for example, information corresponding to the photosensitive drum unit 171b, the transfer belt unit, the transfer roller unit, the fixing unit 174, and the like.

The travel time is a cumulative amount of travel time from the state where the unit is new to the current time point. The travel time is, for example, information corresponding to the photosensitive drum unit 171b, the transfer belt unit, the transfer roller unit, the fixing unit 174, or the like.

The predetermined temperature cumulative time is a cumulative amount of time of a predetermined temperature at the current time point from the state where the unit is new. The predetermined temperature cumulative time is, for example, information corresponding to the fixing unit 174 or the like.

The maximum sheet passing distance is a maximum distance that the unit has passed the sheets from the state where the unit is new to the current time point. For example, this is information corresponding to the fixing unit 174 or the like.

The number of printed sheets is the cumulative number of sheets printed from the state where the unit is new to the current time point. The number of printed sheets is, for example, information corresponding to the photosensitive drum unit 171b, the developing unit, the toner unit, the transfer belt unit, the transfer roller unit, the fixing unit 174, the waste toner conveyance unit, or the like.

The energization time is a cumulative operation time from the state where the unit is new to the current time point. The energization time is, for example, information corresponding to the operation key 12A, the LCD panel 13A, or the like.

### 3. Operation of Image Forming Apparatus

Next, an operation of the image forming apparatus 1 will be described.

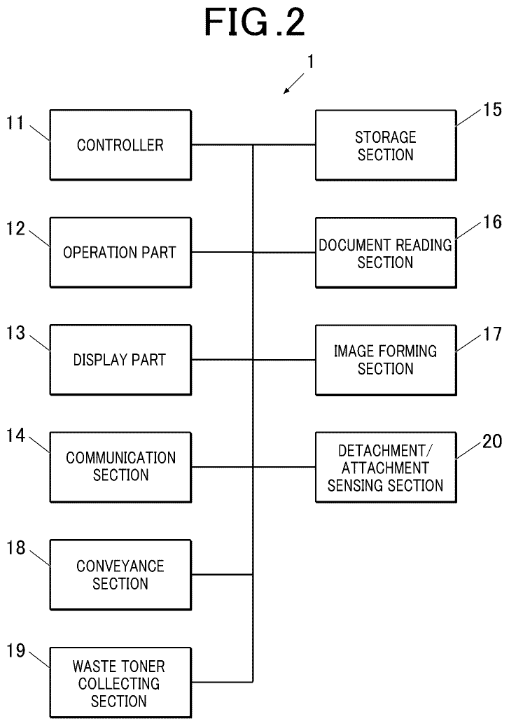

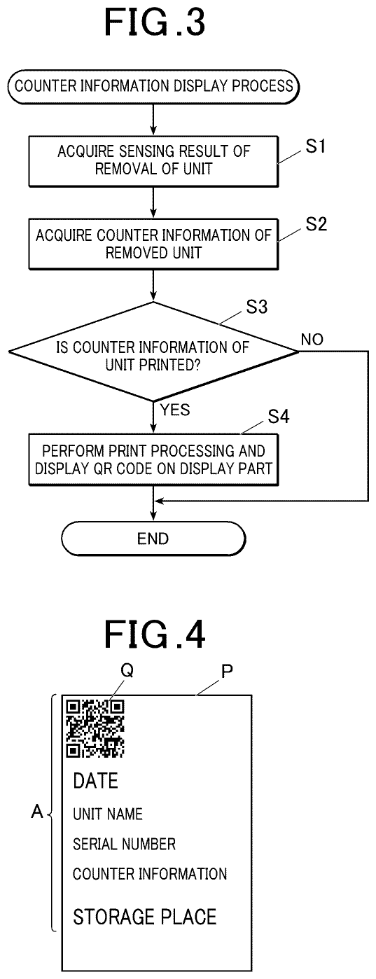

FIG. 3 is a flowchart of a counter information display process executed by the image forming apparatus 1 (discarded apparatus) whose main body is a discarding target.

### (Counter Information Display Process)

In the reuse operation (refurbish operation) of the image forming apparatus 1, an operator sets the operation mode of the discarded apparatus to the refurbish mode. The refurbish mode is a special mode that cannot be used by a general user, and is a mode exclusively for the reuse operation of the unit of the image forming apparatus 1.

Next, the operator takes out the unit to be reused from the main body of the discarded apparatus.

When the unit is detached, the controller 11 of the discarded apparatus acquires a sensing result indicating that the unit has been detached from the detachment/attachment sensing section 20 (step S1).

Next, the controller 11 of the discarded apparatus acquires the counter information of the removed unit from the storage section 15 (step S2).

Next, the controller 11 of the discarded apparatus determines whether the QR code including the counter information of the unit acquired in step S2 is printed on the sheet by the image forming section 17 based on an instruction operation or the like of the user accepted via the operation part 12 (step S3).

If the QR code including the counter information of the unit acquired in step S2 is not to be printed (step S3; NO), the controller 11 of the discarded apparatus ends the counter information display process.

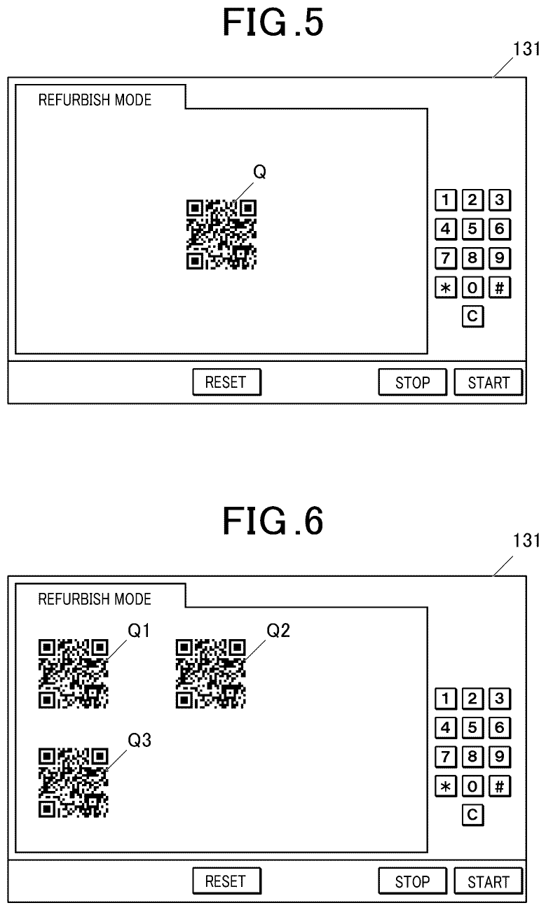

On the other hand, when the QR code including the counter information of the unit acquired in step S2 is to be printed (step S3; YES), the controller 11 of the discarded apparatus generates the QR code including the counter information of the unit acquired in step S2. Next, as illustrated in FIG. 4, the controller 11 of the discarded apparatus causes the image forming section 17 to print handover information A including a generated QR code Q on a sheet P. In addition, as illustrated in FIG. 5, the controller 11 of the discarded apparatus displays the generated QR code Q on the refurbish screen 131 displayed on the display part 13 (step S4), and ends the counter information display process.

As illustrated in FIG. 4, the handover information A includes the QR code Q including the counter information of the unit acquired in step S2, a date on which the handover information A is printed on the sheet P, a name of the unit, a serial number, counter information, a storage place, and the like. The handover information A may include an expiration date of the unit.

That is, in step S4, the controller 11 allows the image forming section 17 to form, on the sheet P, a print image including the state information indicating the state of the unit to be handed over from the image forming apparatus (discarded apparatus) from which the unit is removed to the image forming apparatus (reusing-target apparatus) to which the unit is attached. In addition, the controller 11 displays, on the display part 13, the QR code which is a portion indicating at least the state information of the unit in the print image.

The operator may capture the QR code Q displayed on the refurbish screen 131 in step S4 with a terminal device such as a smartphone or the like and print the captured image by another printing means. Thus, the counter information of the unit can be handed over to the reusing-target apparatus even when the handover information A cannot be printed due to the occurrence of a failure in the image forming section 17 of the discarded apparatus.

In step S2 of the counter information display process, the controller 11 of the discarded apparatus may perform the following process. Specifically, the controller 11 displays the counter information of the removed unit on the display part 13. Next, the controller 11 accepts an operation of selecting the counter information to be handed over to the reusing-target apparatus from the counter information of the removed unit by the user via the operation part 12. In this case, in step S4, the controller 11 generates the QR code including the counter information selected by the user. Next, the controller 11 causes the image forming section 17 to print the handover information A including the generated QR code Q on the sheet P, and also causes the generated QR code Q to be displayed on the refurbish screen 131.

In the above-described counter information display process, if a plurality of units have been removed, in step S4, the controller 11 of the discarded apparatus generates, for each of the removed units, the QR code (e.g., QR codes Q1 to Q3) including the respective counter information.

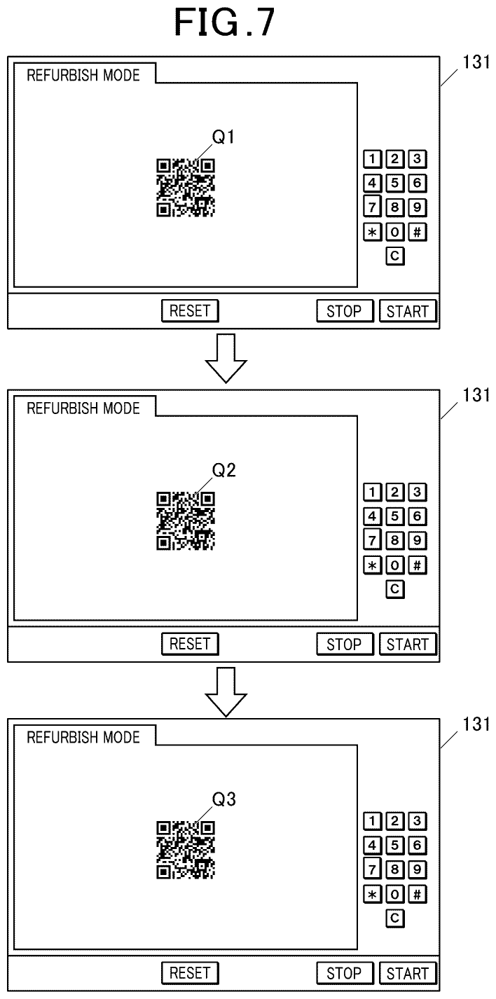

Next, as illustrated in FIG. 6, the controller 11 of the discarded apparatus collectively displays the QR codes Q1 to Q3 corresponding to the respective units on the refurbish screen 131. That is, when there are a plurality of units to be removed from the image forming apparatus 1 as the discarded apparatus, the controller 11 displays portions (QR codes Q1 to Q3) indicating a plurality of state information respectively corresponding to the plurality of units aligned on the same screen displayed on the display part 13. Alternatively, as illustrated in FIG. 7, the controller 11 of the discarded apparatus sequentially switches and displays the QR codes Q1 to Q3 on the refurbish screen 131 every predetermined amount of time. That is, when there are a plurality of units to be removed from the image forming apparatus 1 serving as the discarded apparatus, the controller 11 sequentially switches and displays, on the display part 13, the portions (QR codes Q1 to Q3) indicating the plurality of state information respectively corresponding to the plurality of units.

In step S4 of the above-described counter information display process, the controller 11 of the discarded apparatus may generate the QR code including the image data for printing the handover information A on the sheet P by the image forming section 17. In this case, the controller 11 of the discarded apparatus displays the QR code including the image data for printing the handover information A on the sheet P by the image forming section 17 on the refurbish screen 131.

That is, the controller 11 causes the display part 13 to display the code image for restoring the print image including the state information of the unit.

After the counter information display process, the operator pastes the sheet printed in step S4 to the corresponding unit, and stores it as a stock of a used unit.

Next, the operator takes out the used unit stored as the stock and the sheet on which the handover information A on the unit is printed from the storage place. Next, the operator attaches the taken used unit to the main body of another image forming apparatus 1 (reusing-target apparatus). Next, the operator reads the QR code printed on the sheet with the document reading section 16 of the reusing-target apparatus. Thus, the reusing-target apparatus acquires the counter information on the used unit and stores the acquired counter information in the storage section 15.

By the above-described reproducing operation, the counter information of the attached used unit can be taken over in the reusing-target apparatus.

### 4. Modification Example

Although the present embodiment has been described above, the specific configuration is not limited to the above-described present embodiment and can be changed without departing from the scope of the invention. Hereinafter, modification examples of the present embodiment will be described. In the modification example, components similar to those of the above-described embodiment are denoted by the same reference numerals, and description thereof will be omitted.

### Modification Example 1

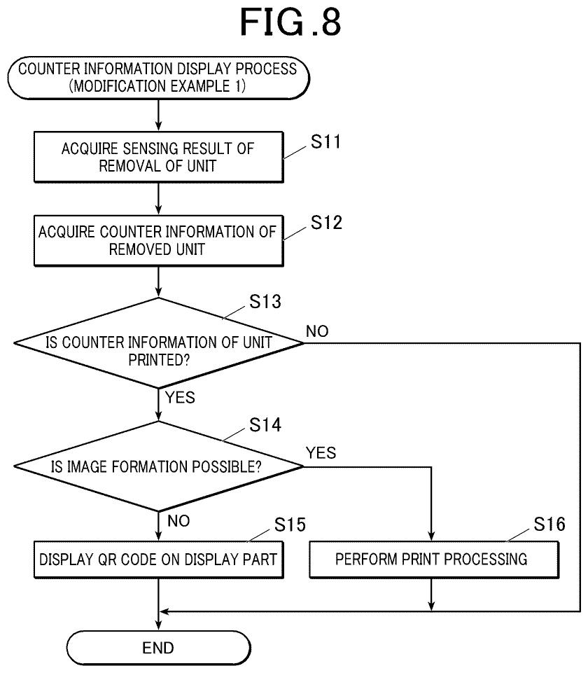

FIG. 8 is a flowchart of the counter information display process executed by the discarded apparatus according to modification example 1.

In the counter information display process of modification example 1, the controller 11 of the discarded apparatus executes steps S11 to S13 similar to steps S1 to S3 of the above-described embodiment.

When the QR code including the counter information of the unit acquired in step S12 is to be printed (step S13; YES), the controller 11 of the discarded apparatus determines whether the image forming section 17 is in a printable state (step S14).

When a failure or the like has occurred in the image forming section 17 and the image formation cannot be performed (step S14; NO), the controller 11 of the discarded apparatus does not execute the print processing by the image forming section 17. In addition, the controller 11 displays the QR code including the counter information of the unit acquired in step S12 on the refurbish screen 131 displayed on the display part 13 (step S15), and ends the counter information display process.

That is, when the image formation by the image forming section 17 is not possible, the controller 11 displays, on the display part 13, the QR code which is the portion indicating at least the state information of the unit in the print image including the state information of the unit.

On the other hand, if the image forming section 17 can form the image (step S14; YES), the controller 11 of the discarded apparatus causes the image forming section 17 to print the handover information including the QR code including the counter information of the unit acquired in step S12 on the sheet (step S16), and ends the counter information display process.

### Modification Example 2

In modification example 2, the operator captures the image of the QR code displayed on the refurbish screen 131 with an imaging apparatus such as a camera communicably connected to the discarded apparatus. In the imaging apparatus, when a shutter button for instructing capture is depressed by the operator, the imaging apparatus executes photographing and transmits a capture execution notification indicating that capture is executed to the discarded apparatus.

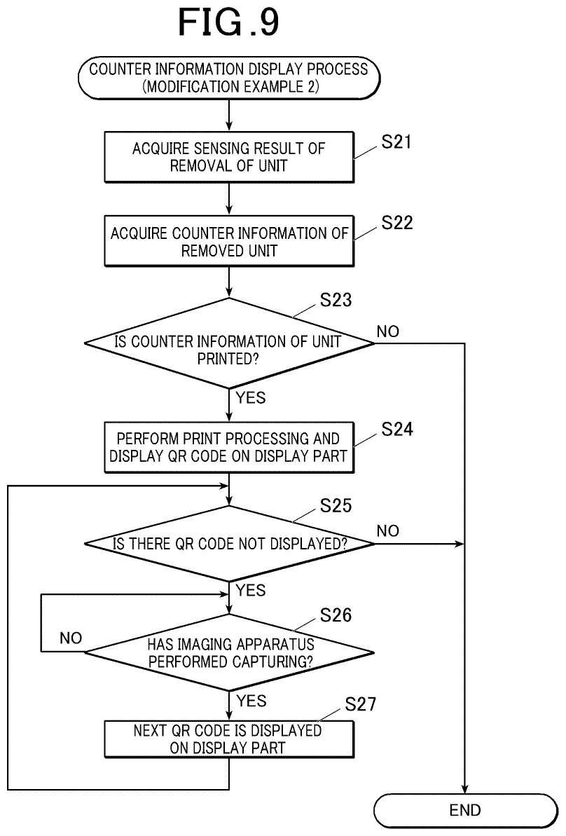

FIG. 9 is a flowchart of the counter information display process executed by the discarded apparatus according to the second modification example.

In the counter information display processing of modification example 2, the controller 11 of the discarded apparatus executes steps S21 to S23 similar to steps S1 to S3 of the above-described embodiment.

When the QR code including the counter information of the unit acquired in step S22 is to be printed (step S23; YES), the controller 11 of the discarded apparatus generates the QR code including the counter information of the unit acquired in step S22. Next, the controller 11 of the discarded apparatus causes the image forming section 17 to print the handover information including the generated QR code on the sheet. In addition, the controller 11 of the discarded apparatus displays the generated QR code on the refurbish screen 131 (step S24). If a plurality of units have been detached, in step S24, the controller 11 generates, for each of the detached units, the QR code including the respective counter information. Next, the controller 11 displays one of the plurality of generated QR codes on the refurbish screen 131.

Next, the controller 11 of the discarded apparatus determines whether there is the QR code that is not displayed in the refurbish screen 131 among the QR codes generated in step S24 (step S25).

When there is no QR code that is not displayed on the refurbish screen 131 (step S25; NO), the controller 11 of the discarded apparatus ends the counter information display process.

On the other hand, when there is the QR code that is not displayed on the refurbish screen 131 (step S25; YES), the controller 11 of the discarded apparatus determines whether the capture execution notification has been received from the imaging apparatus. That is, the controller 11 of the discarded apparatus determines whether the imaging apparatus has captured the QR code displayed on the refurbish screen 131 (step S26).

When the imaging apparatus is not performing capturing (step S26; NO), the controller 11 of the discarded apparatus returns the counter information display process to step S26.

On the other hand, if the imaging apparatus captured the image (step S26; YES), the controller 11 of the discarded apparatus displays, on the refurbish screen 131, the QR code that has not yet been displayed on the refurbish screen 131 among the QR codes generated in step S24 (step S27). Next, the controller 11 of the discarded apparatus shifts the counter information display process to step S25.

In the counter information display process of the modification example 2, the controller 11 of the discarded apparatus switches the portion (QR code) indicating the state information of the unit displayed on the display part 13 at the timing of receiving the notification (imaging execution notification) indicating that the capture has been executed from the imaging apparatus communicably connected to the image forming apparatus 1 as the discarded apparatus.

### Modification Example 3

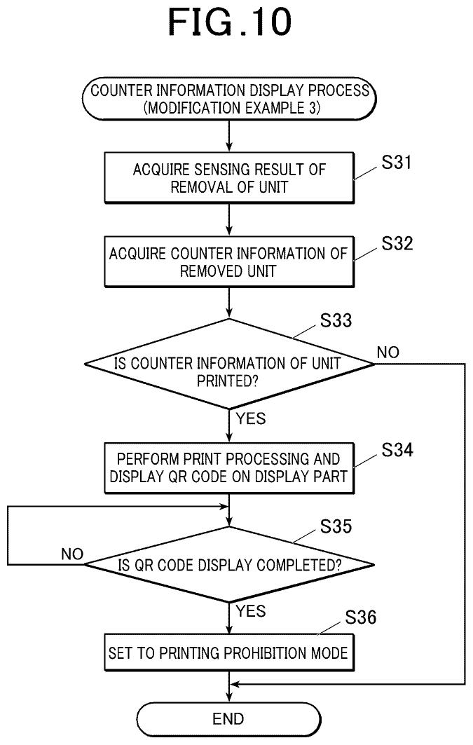

FIG. 10 is a flowchart of a counter information display process executed by the discarded apparatus according to the modification example 3.

In the counter information display processing of modification example 3, the controller 11 of the discarded apparatus executes steps S31 to S34 similar to steps S1 to S4 of the above-described embodiment.

Next, the controller 11 of the discarded apparatus determines whether the display of the QR code on the refurbish screen 131 is completed (step S35). For example, if a predetermined amount of time has elapsed after the controller 11 of the discarded apparatus displays the QR code on the refurbish screen 131 in step S34, the controller 11 determines that the display of the QR code is completed.

When the display of the QR code is not completed (step S35; NO), the controller 11 of the discarded apparatus returns the counter information display process to step S35.

On the other hand, in a case where the display of the QR code is completed (step S35; YES), the controller 11 of the discarded apparatus sets the operation mode of the discarded apparatus to a printing prohibition mode in which printing by the image forming section 17 is prohibited (printing is restricted) (step S36), and ends the counter information display process.

That is, in the counter information display process of modification example 3, the controller 11 of the discarded apparatus restricts image formation processing by the image forming section 17 after completion of display of the portion indicating the state information of the unit (QR code) on the display part 13. The controller 11 functions as a restriction section.

Thus, the counter information included in the QR code displayed on the refurbish screen 131 is different from the counter information after the print processing executed after the display of the QR code, so that it is possible to prevent erroneous counter information from being taken over to the reusing-target apparatus.

### 5. Effect

As described above, the image forming apparatus 1 according to the present embodiment is an image forming apparatus including a unit and an image forming apparatus main body to which the unit is attached.

The image forming apparatus 1 includes an image forming section 17 that forms the image on the sheet.

The image forming apparatus 1 includes the controller 11 that causes the image forming section 17 to form, on the sheet, the print image including the state information indicating the state of the unit to be handed over from the image forming apparatus from which the unit is removed to the image forming apparatus to which the unit is attached in the refurbishing operation, and that causes the display part 13 to display at least the portion (QR code image) indicating the state information of the unit in the print image.

Therefore, even if the image forming section 17 of the discarded apparatus has a problem and cannot print the handover information, the operator can hand over the counter information of the unit to the reusing-target apparatus on the basis of the QR code displayed on the display part 13. Thus, the information (counter information) indicating the state of the unit removed from the provider apparatus can be suitably handed over to the receiver apparatus.

According to the image forming apparatus 1 of the present embodiment, when the image formation by the image forming section 17 is not possible, the controller 11 displays, on the display part 13, the portion (QR code image) indicating at least the state information of the unit in the print image including the state information of the unit.

Therefore, when a failure occurs in the image forming section 17 of the discarded apparatus and the handover information cannot be printed, the operator can hand over the counter information of the unit to the reusing-target apparatus based on the QR code displayed on the display part 13.

According to the image forming apparatus 1 of the present embodiment, when there are a plurality of units to be removed from the image forming apparatus 1, the controller 11 displays the portion (QR code image) indicating a plurality of state information respectively corresponding to the plurality of units aligned on the same screen displayed on the display part 13.

Therefore, the operator can capture the image of the plurality of state information respectively corresponding to a plurality of units displayed on the display part 13 at one time with the terminal device such as the smartphone.

According to the image forming apparatus 1 of the present embodiment, when there are a plurality of units to be removed from the image forming apparatus 1, the controller 11 sequentially switches and displays, on the display part 13, the portion (QR code image) indicating the plurality of state information respectively corresponding to the plurality of units.

Therefore, the plurality of state information respectively corresponding to the plurality of units displayed on the display part 13 can be sequentially switched and displayed without the operation for switching the display by the operator.

According to the image forming apparatus 1 of the present embodiment, the controller 11 switches the portion (QR code) indicating the state information of the unit displayed on the display part 13 at the timing of receiving the notification indicating that the capture has been executed from the imaging apparatus communicably connected to the image forming apparatus 1.

Therefore, the plurality of state information respectively corresponding to the plurality of units displayed on the display part 13 can be sequentially switched and displayed without the operation for switching the display by the operator.

The image forming apparatus 1 according to the present embodiment includes a sensing section (detachment/attachment sensing section 20) that senses detachment of the unit from the main body of the image forming apparatus.

The controller 11 displays, on the display part 13, the portion (QR code image) indicating the state information corresponding to the unit whose removal is sensed by the sensing section.

Therefore, it is possible to save time and effort for the operator to specify the unit to be detached from the image forming apparatus main body.

In the image forming apparatus 1 of the present embodiment, the controller 11 displays the code image for restoring the print image including the state information of the unit on the display part 13.

Therefore, even if the image forming section 17 of the discarded apparatus has a problem and cannot print the handover information, the operator can hand over the counter information of the unit to the reusing-target apparatus on the basis of the QR code including the print image displayed on the display part 13.

The image forming apparatus 1 of the present embodiment includes a restriction unit (controller 11) that restricts the image formation processing by the image forming section 17 after the controller 11 completes the display of the portion (QR code image) indicating the state information of the unit on the display part 13.

Therefore, the counter information included in the QR code displayed on the refurbish screen 131 is different from the counter information after the print processing executed after the display of the QR code, so that it is possible to prevent erroneous counter information from being taken over to the reusing-target apparatus.

The description in the above embodiment is an example of the image forming apparatus and the program according to the present invention, and the present invention is not limited thereto. The detailed configuration and detailed operation of each apparatus constituting the system can be appropriately modified without departing from the scope of the present invention.

For example, in the above-described embodiment and modification example, the controller 11 may generate a two dimensional code other than the QR code including the counter information of the unit, instead of the QR code including the counter information of the unit removed from the image forming apparatus main body.

Further, in the above-described embodiment and modification example, the program for executing each process in each device may be stored in a portable recording medium. Further, a carrier wave may be applied as a medium for providing program data via a communication line.

Although embodiments of the present invention have been described and shown in detail, the disclosed embodiments are made for purposes of illustration and example only and not limitation. The scope of the present invention should be interpreted by terms of the appended claims.

The entire disclosure of Japanese Patent Application No. 2024-091107, filed on Jun. 5, 2024, including description, claims, drawings and abstract is incorporated herein by reference.

What is claimed is:

1. An image forming apparatus including a unit and an image forming apparatus main body to which the unit is attached, the image forming apparatus comprising:
an image former that forms an image on a sheet;
and a hardware processor that forms, on the sheet by the image former, a print image including state information indicating a state of the unit to be handed over from the image forming apparatus from which the unit is detached to the image forming apparatus to which the unit is attached in a refurbish operation, and displays, on a display, at least a portion of the print image indicating the state information.

2. The image forming apparatus according to claim 1, wherein the hardware processor is configured to, in a case in which image formation by the image former is not possible, display, on the display, at least the portion of the print image indicating the state information.

3. The image forming apparatus according to claim 1, wherein in a case in which a plurality of the units are detached from the image forming apparatus, the hardware processor displays the portions indicating the plurality of the state information respectively corresponding to the plurality of units aligned on the same screen displayed on the display.

4. The image forming apparatus according to claim 1, wherein in a case in which a plurality of units are detached from the image forming apparatus, the hardware processor sequentially switches and displays the portions indicating the plurality of the state information corresponding to the plurality of units on the display.

5. The image forming apparatus according to claim 4, wherein the hardware processor switches the portion indicating the state information displayed on the display at a timing of receiving a notification indicating that capturing is executed from an imaging apparatus communicably connected to the image forming apparatus.

6. The image forming apparatus according to claim 1,
further comprising a sensor that senses removal of the unit from the image forming apparatus main body,
wherein the hardware processor displays, on the display, the portion indicating the state information corresponding to the unit whose removal is sensed by the sensor.

7. The image forming apparatus according to claim 1, wherein the hardware processor displays a code image that restores the print image on the display.

8. The image forming apparatus according to claim 1, wherein the hardware processor restricts image formation processing by the image former after the hardware processor completes display of the portion indicating the state information on the display.

9. A non-transitory computer readable storage medium comprising a program that causes a computer of an image forming apparatus including a unit, an image forming apparatus main body to which the unit is attached, and an image former that forms an image on a sheet, to perform:
forming, on the sheet by the image former, a print image including state information indicating a state of the unit to be handed over from the image forming apparatus from which the unit is detached to the image forming apparatus to which the unit is attached in a refurbish operation, and displaying, on a display, at least a portion of the print image indicating the state information.
